(19) United States
(12) Patent Application Publication
(10) Pub. No.: US 2012/0076149 A1
(43) Pub. Date: Mar. 29, 2012

(54) Transmission bandwidth quality of service

(75) Inventors: Kung-Ling Ko, Union City, CA (US); Tony Nguyen, SAN JOSE, CA (US); Venkata Pramod Balakavi, San Jose, CA (US)

(73) Assignee: BROCADE COMMUNICATIONS SYSTEMS, INC., San Jose, CA (US)

(21) Appl. No.: 12/889,224

(22) Filed: Sep. 23, 2010

(51) Int. Cl. H04L 12/28; H04L 12/56

(52) U.S. Cl. 370/395.53; 370/401

(57) ABSTRACT

A bandwidth limiting circuit provides limiting the bandwidth of a group of virtual channels at a transmitting port to a maximum value. A limiting circuit includes a register that is repeatedly incremented with a threshold value, which threshold value is related to the desired maximum bandwidth for the group. The register is decremented by the frame length, in bytes, of the frame transmitted from one of the virtual channels belonging to the group. A comparator enables frame transmission for the group if the register value is greater than zero. A bandwidth guarantee circuit provides at least the bandwidth specified by the limiting circuit. The guarantee circuit enables one of the groups for frame transmission based on a fairness algorithm when the outputs of comparators of each of the limiting circuit are low.

### BACKGROUND OF THE INVENTION

1. Field of the Invention

The present invention relates generally to networks. Particularly, the present invention relates to transmission bandwidth control.

2. Description of the Related Art

Storage networks can comprise several Fibre Channel switches interconnected in a fabric topology. These switches are interconnected by a number of inter-switch links (ISLs), which carry both data and control information. An ISL is terminated at a port on each of the two switches it connects to. The ISL typically provides a physical link between the two switches. Frames/packets can be transmitted between the switch ports over the ISL. The rate at which these packets can be transmitted depends upon, among other factors, the bandwidth provided at the port and the buffer-to-buffer credit established between the two ports connected by the ISL.

Typically, traffic transmitted from one switch port to another, via an ISL, can consist of multiple flows, where each flow can be associated with a pair of devices within the storage network (e.g., host-storage device pair). Frames associated with these flows are temporarily stored in a buffer associated with the transmitter of the port before being transmitted. If only a single buffer is used per transmitter, a single flow may block the frames associated with other flows. To mitigate this problem, the ISL can be logically split into one or more virtual channels (VCs), where each VC has an associated buffer. Data flows can then be directed over separate VCs to avoid blocking. Each VC can support one or more data flows.

The bandwidth provided by a port can be divided among the VCs associated with that port. For example, a port having a 10 Gbps transmitting bandwidth and 10 VCs can allow each VC equal transmitting bandwidth of 1 Gbps. However, such schemes, employing fair division, may be disadvantageous when one or more VCs include data flows that deserve more bandwidth than data flows on other VCs. For example, a data flow between two mission-critical applications may require and deserve more bandwidth than a data flow for simple data backup. Thus, traffic through different VCs can have different quality of service (QoS) requirements. In such cases weighted division of bandwidth can allocate bandwidth to a VC based on its assigned weight. However, these methods do not provide precise individual control over the bandwidths assigned to one or more VCs.

Another technique for bandwidth control is called credit throttling. In credit throttling, a receiving port can throttle the number of credits sent to a transmitting port on the other end of an ISL in order to control the received bandwidth at the receiving port. However, in this case the transmitter itself has no control over its transmission bandwidth. The receiving port connected on the other end of the ISL controls the transmission bandwidth of the transmitter.

### SUMMARY OF THE INVENTION

An input/output port on a switch can be connected to an input/output port on an adjacent switch using inter-switch links (ISLs). Traffic flow between the two ports can be divided into logical channels or virtual channels (VCs). The transmitter can maintain a separate queue for each VC.

A bandwidth limiting circuit can be coupled with the transmitting port for controlling the bandwidth of one or more VCs associated with that port. The bandwidth limiting circuit can include a register that is initially loaded with a threshold value TH, which threshold value is related to the maximum bandwidth allocated for the associated group of VCs. The register is incremented periodically (at a rate r) with the threshold value. The register is decremented by the frame length in bytes each time a frame is transmitted from one of the VCs belonging to the group. A comparator compares the register value to zero. The group is enabled to transmit a frame when the register value is greater than zero. The maximum bandwidth allocated to the group of VCs can be determined approximately by the ratio of the threshold value TH and the rate r.

A bandwidth guarantee circuit associated with a group of VCs guarantees the group of VCs with a minimum bandwidth. The bandwidth guarantee circuit includes bandwidth limiting circuits associated with each group of VCs. Additionally, the bandwidth circuit enables a group of VCs based on a fairness algorithm if the output of comparators of all the bandwidth limiting circuits is zero. As a result, the bandwidth guarantee circuit guarantees at least a minimum bandwidth determined by the bandwidth limiting circuit and provides additional bandwidth based on the fairness algorithm.

The sum of bandwidths of all groups should be less than or equal to the maximum bandwidth provided by the port.

Bandwidth limiting and bandwidth guarantee can also be provided on host bus adaptors within a host device connected to the network.

### BRIEF DESCRIPTION OF THE DRAWINGS

The present invention has other advantages and features which will be more readily apparent from the following detailed description of the invention and the appended claims, when taken in conjunction with the accompanying drawings, in which:

FIG. 1 illustrates a Fibre Channel network communication system according to an embodiment of the present invention;

FIGS. 2A and 2B shows detailed view of two switches interconnected with an inter-switch link according to an embodiment of the present invention;

FIG. 3 illustrates a schematic of a bandwidth limiting circuit according to an embodiment of the present invention;

FIG. 4 shows a flowchart describing exemplary operation of the bandwidth limiting circuit of FIG. 3;

FIG. 5 illustrates exemplary values of the counter register of FIG. 3 over time;

FIG. 6 illustrates a schematic of a bandwidth guarantee circuit according to an embodiment of the present invention; and

FIGS. 7A and 7B show flowcharts describing exemplary operation of the bandwidth guarantee circuit of FIG. 6.

### DETAILED DESCRIPTION

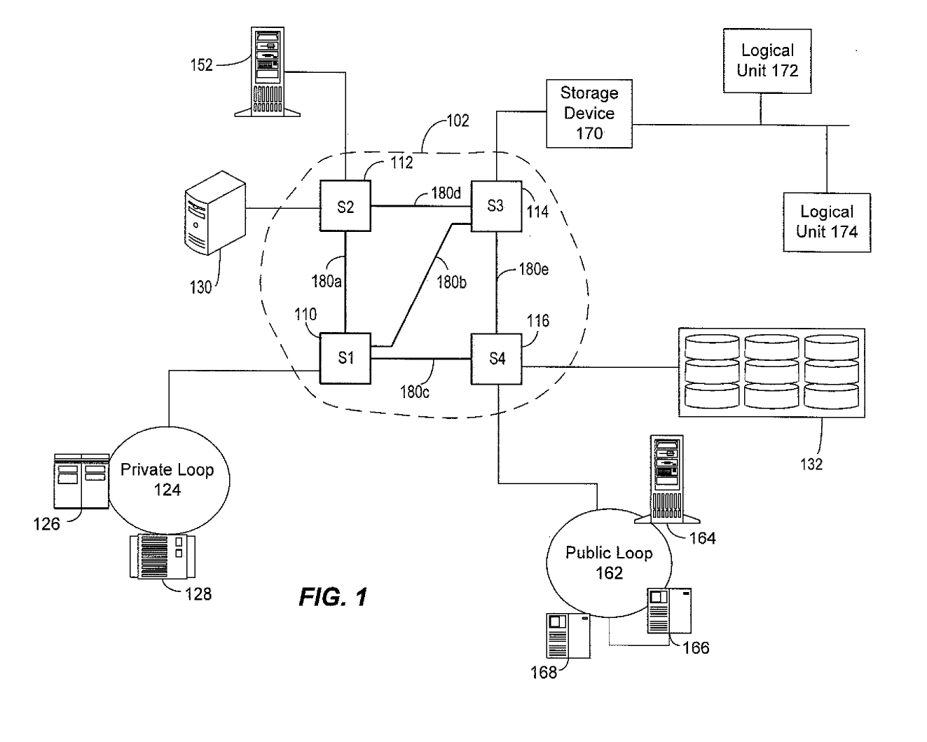

FIG. 1 illustrates a Fibre Channel network 100 including various network, storage, and user devices. It is understood that Fibre Channel is only used as an example and other network architectures, such as Ethernet, FCoE, iSCSI, and the like, could be utilized. Furthermore, the network 100 can represent a “cloud” providing on-demand network access to a shared pool of configurable computing resources (e.g., networks, servers, storage, applications, and services). The network can also represent a converged network such as Fibre Channel over Ethernet. Generally, in the preferred embodiment the network 100 is connected using Fibre Channel connections (e.g., optical fiber and coaxial cable). In the embodiment shown and for illustrative purposes, the network 100 includes a fabric 102 comprised of four different switches S1 110, S2 112, S3 114, and S4 116. It will be understood by one of skill in the art that a Fibre Channel fabric may be comprised of one or more switches.

A variety of devices can be connected to the fabric 102. A Fibre Channel fabric supports both point-to-point and loop device connections. A point-to-point connection is a direct connection between a device and the fabric. A loop connection is a single fabric connection that supports one or more devices in an “arbitrated loop” configuration, wherein signals travel around the loop through each of the loop devices. Hubs, bridges, and other configurations may be added to enhance the connections within an arbitrated loop.

On the fabric side, devices are coupled to the fabric via fabric ports. A fabric port (F_Port) supports a point-to-point fabric attachment. A fabric loop port (FL_Port) supports a fabric loop attachment. Both F_Ports and FL_Ports may be referred to generically as Fx_Ports. Typically, ports connecting one switch to another switch are referred to as expansion ports (E_Ports). In addition, generic ports may also be employed for fabric attachments. For example, G_Ports, which may function as either E_Ports or F_Ports, and GL_Ports, which may function as either E_Ports or Fx_Ports, may be used.

On the device side, each device coupled to a fabric constitutes a node. Each device includes a node port by which it is coupled to the fabric. A port on a device coupled in a point-to-point topology is a node port (N_Port). A port on a device coupled in a loop topology is a node loop port (NL_Port). Both N_Ports and NL_Ports may be referred to generically as Nx_Ports. The label N_Port or NL_Port may be used to identify a device, such as a computer or a peripheral, which is coupled to the fabric.

In the embodiment shown in FIG. 1, fabric 102 includes switches S1 110, S2 112, S3 114, and S4 116 that are interconnected. Switch S1 110 is attached to private loop 124, which is comprised of devices 126 and 128. Switch S2 112 is attached to device 152 and device 130, which may also provide a user interface. Switch S3 114 is attached to device 170, which has two logical units 172, 174 attached to device 170. Typically, device 170 is a storage device such as a RAID device, which in turn may be logically separated into logical units illustrated as logical units 172 and 174. Alternatively the storage device 170 could be a JBOD or just a bunch of disks device, with each individual disk being a logical unit. Switch S4 116 is attached to public loop 162, which is formed from devices 164, 166 and 168 being communicatively coupled together. Switch S4 116 is also attached to storage device 132, which can be a JBOD. Although not explicitly shown, the network 100 can include one or more zones. A zone indicates a group of source and destination devices allowed to communicate with each other.

Switches S1 110, S2 112, S3 114, and S4 116 are connected with one or more inter-switch links (ISLs). Switch S1 110 can be connected to switches S2 112, S3 114, and S4 116, via ISLs 180a, 180b, and 180c, respectively. Switch S2 112 can be connected to switches S3 114 by ISL 180d. Switch S3 114 can be connected to switch S4 116 via ISL 180e. Note that although only single links between various switches have been shown, links between any two switches can include multiple ISLs. The fabric can use link aggregation or trunking to form single logical links comprising multiple ISLs between two switches. For example, if 180a comprised of three 2 Gbps ISLs, the three ISLs can be aggregated into a single logical link between switches S1 110 and S2 112 with a bandwidth equal to the sum of bandwidth of the individual ISLs, i.e. 6 Gbps. It is also conceivable to have more than one logical links between two switches where each logical link is composed of one or more trunks. The fabric 102 with multiple switches interconnected with ISLs can provide multiple paths with multiple bandwidths for devices to communicate with each other.

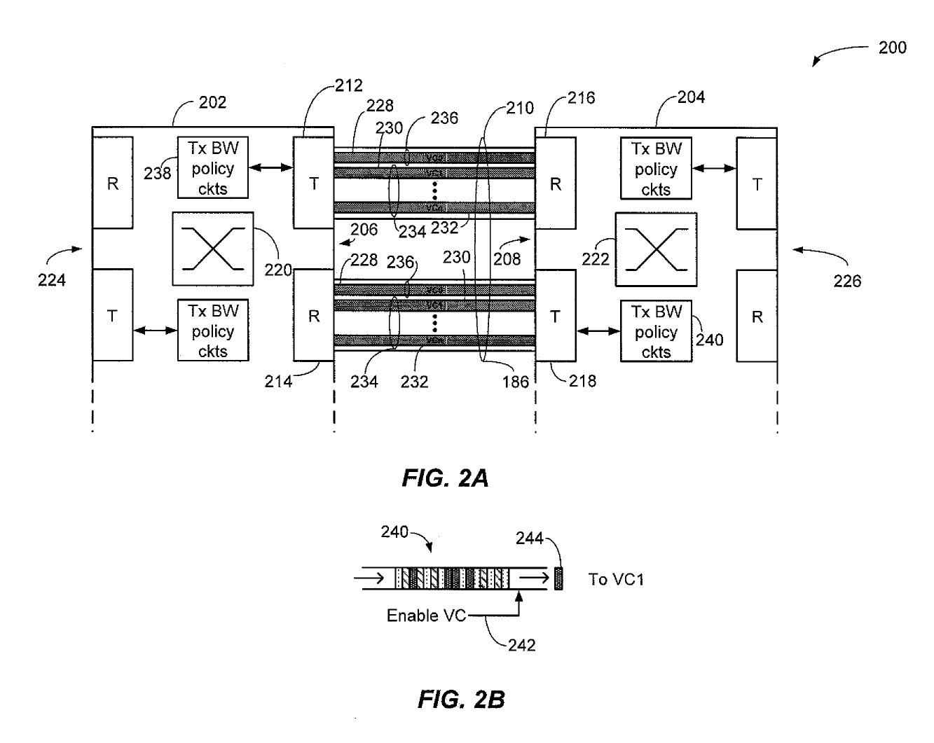

FIG. 2A illustrates two switches 202 and 204 having ports 206 and 208 connected via an ISL 210. Each port can have a receiver and transmitter. Port 206 includes transmitter 212 and receiver 214. Similarly, port 208 on switch 204 includes transmitter 218 and receiver 216. Each switch can further include switch constructs 220 and 222. A switch construct can include a crossbar switch or equivalent circuit and control logic. A switch construct can direct frames received at any port in the switch to any other port on the same switch. Switches 202 and 204 can also include additional ports, such as ports 224 and 226. The broken lines at the bottom of the switches 202 and 204 denote that the switch can include additional ports and processing modules, but that the illustration is focused on the ports 206 and 208.

Ports 206 and 208 can include one or more logical channels VC0 228-VCn 232, also known as virtual channels in Fibre Channel networks. Each virtual channel is allocated its own queue within the switch. The transmitter 212, for example, determines the virtual channel that an outgoing frame needs to be on. The transmitter 212 can then place the frame in the queue corresponding to that virtual channel. Typically, frames with the same source and destination (denoted by, e.g., S_ID and D_ID) pair are sent and received via the same virtual channel. However, each virtual channel can carry frames having various source destination pairs. In other words, each virtual channel VC0 228-VCn 232 can carry frames associated with different data flows.

Note that the virtual channel concept in FC networks should be distinguished from “virtual circuit” (which is sometimes also called “virtual channel”) in ATM networks. An ATM virtual circuit is an end-to-end data path with a deterministic routing from the source to the destination. That is, in an ATM network, once the virtual circuit for an ATM cell is determined, the entire route throughout the ATM network is also determined. In contrast, an FC virtual channel is a local logical channel for a respective link between switches. That is, an FC virtual channel only spans over a single link. When an FC data frame traverses a switch, the virtual channel information can be carried by appending a temporary tag to the frame. This allows the frame to be associated to the same VC identifier on outgoing link of the link. However, the VC identifier does not determine a frame's routing, because frames with different destinations can have the same VC identifier and be routed to different outgoing ports. An ATM virtual circuit, on the other hand, spans from the source to the destination over multiple links. Furthermore, an FC virtual channel carries FC data frames, which are of variable length. An ATM virtual circuit, however, carries ATM cells, which are of fixed length. Furthermore, frames having different end-to-end routes may share the same FC virtual channel. In contrast, all the data cells in an ATM virtual circuit belong to the same source/destination pair.

Referring back to FIG. 2A, one or more virtual channels can be combined into groups. For example, VC1-VCn can be assigned to one VC group, Goup1 234; VC0 can be assigned to a one member group, Group0 236. VCs within a group can share the bandwidth assigned to that group.

Switches 202 and 204 can also include transmitter bandwidth policy circuits 238 and 240 associated with transmitters 212 and 218 respectively. Policy circuit 202 allows the switch 202 to establish bandwidth policies related to each virtual channel or each group of virtual channels. Policy circuit 238 can include bandwidth limiting and bandwidth guarantee circuits (discussed in further detail below) associated with each VC or each group. For example, policy circuits 238 can include n bandwidth limiting circuits and n bandwidth guarantee circuits, where n is the total number of virtual channels VC0 228-VCn 232 supported by port 206. Alternatively, the number of bandwidth limiting and bandwidth guarantee circuits can be equal to the maximum number of groups of VCs that can be allocated per port. For example, if port 206 can assign a maximum of 48 different groups of VCs, then the policy circuits can include 48 bandwidth limiting circuits and 48 bandwidth guarantee circuits.

Frames associated with a VC are input to the VC's queue for transmission. Several factors dictate when a frame on the head of a VC's queue is eligible for transmission. For example, these factors can include speed matching, credit availability, class of service, de-skew time, and bandwidth availability. In case of bandwidth availability, the bandwidth policy circuits 238 can send an enable signal to the appropriate queue at the transmitter 212 to indicate that the frame at the head of that queue has met the bandwidth policy requirement, and is ready to be transmitted. For example, FIG. 2B shows an exemplary queue for VC1 where an enable signal 242 allows frame 244 on the head of the queue to be transmitted. Enable signal 242 is the result of a combination of factors mentioned before, such as speed matching, credit availability, class of service, de-skew time, and bandwidth availability. As far as bandwidth availability is concerned, this signal can be provided by a transmitter bandwidth policy circuit 238 associated with VC1.

When VCs are combined into a group, an enable signal for the group signifies that a frame at the head of any one of the queues associated with the VCs in the group can be transmitted. The VC, and the associated queue, can be selected based on the group policy. For example, if a fairness policy is observed, each VC will be selected in turn every time an enable signal is received. Of course, other selection schemes, such as weighted priority, random selection, etc. can also be employed. As stated earlier, a group may include only a single VC, and in such cases receiving a group enable signal will enable the frame on the head of the queue associated with that single VC.

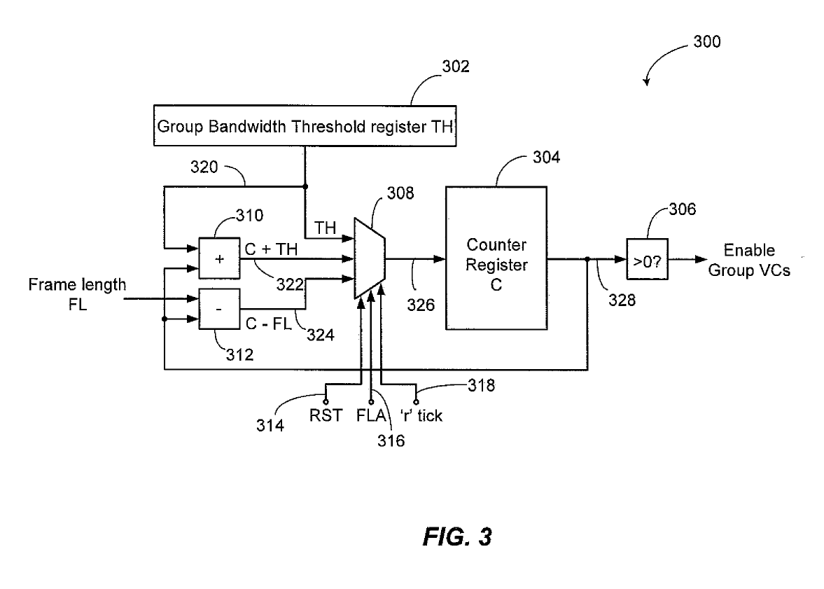

Discussion now turns to the transmitter bandwidth policy circuits 238 (and 240). FIG. 3 illustrates an exemplary bandwidth (BW) limiting circuit 300 for implementing bandwidth limiting for a particular group of VCs. A Group Bandwidth Threshold Register 302 is loaded with a value, which, in part, determines the maximum bandwidth assigned to the corresponding group of VCs. The relationship between the value stored in the threshold register 302 and the maximum bandwidth is discussed further below. For now, as shown in FIG. 3, this value is symbolically represented by ‘TH’.

Group BW limiting circuit 300 includes a group counter register C 304 that stores a value, based on which the group's VCs are enabled. Size of register C 304 is typically the same or larger than the size of threshold register 302. Assuming that the size is n bits, the counter register C 304 can be built using n flip-flops. Of course, other well known digital structures for storing a series of bits can also be employed. Although the inputs and output signals/interconnects in FIG. 3 have been shown as a single lines, they can represent buses with widths equal to the width of the counter register C 304.

Input to counter register C 304 is controlled by 3-to-1 multiplexer 308. Multiplexer 308 receives three data inputs: one from the threshold register 302, one from adder 310 and one from subtracter 312. Control inputs RST 314, FLA 316, and ‘r’ tick 318 determine which one of the three inputs to the multiplexer 308 is provided to the counter register C 304. Control input RST 314 can be a reset signal that is asserted on power-up or when the counter register C 304 needs to be reset to an initial value. Control signal FLA 316 (Frame Length Available) can be received whenever the frame length of a frame that is transmitted from a VC belonging to the group becomes available. Control input ‘r’ tick 318 can be a periodic pulse signal that activates every ‘r’ seconds. Alternatively, ‘r’ tick 318 can be a non periodic signal, but that on average can provide a predetermined number of pulses per second. When control input RST 314 is asserted, the multiplexer 308 can pass the output of threshold register 302 to the counter register 312. When control input ‘r’ tick 318 is asserted, multiplexer 308 can pass the output of adder 310 to the input of counter register C 304. And when input FLA 316 is asserted, output of the subtracter 312 can be passed to the input of the counter register C 304.

Adder 310 can add the value TH stored in the threshold register 302 to the current value stored in the counter register C 304. The resultant value, C+TH, can then be loaded into the counter register C 304 every ‘r’ seconds. Subtracter 312 can subtract the value FL, representing the length of the frame (in bytes) that has been transmitted, from the current value stored in the counter register C 304. The resultant value, C−FL, can then be loaded into the counter register C 304 when control signal FLA is asserted. Adder 310 and subtracter 312 can be n-bits in size and can carry out 2's complement addition and subtraction. In other words, they can operate with both positive and negative numbers. A 2's complement representation of numbers usually represents negative numbers with a value ‘1 ’ in the MSB, and represents positive numbers with a value ‘0’ in the MSB. Operationally, the BW limiting circuit 300 increments the counter register C 304 by a value TH every ‘r’ seconds, and decrements the counter register C 304 by a value FL whenever a frame is transmitted by a VC belonging to the group.

Output of the counter register C 304 can be fed to a comparator 306, which compares the value stored in the counter register C 304 to 0. If the value is greater than 0 then the output of the comparator can be a single bit ‘1’, and if the value is less than or equal to 0 then the output of the comparator can be a single bit ‘0’. Output of the comparator 306 can be fed to the group VC enable signal, which can allow at least one frame associated with the VCs from the group scheduled for transmission to be transmitted. Therefore, if the value in the counter register C 304 is greater than 0, then the group VCs can be enabled for transmitting frames, otherwise the group VCs can be disabled for transmission. Note that the value chosen for comparison may be different than 0. For example, the value for comparison can be approximately equal to 0, such as −1, −2, +1, +2, etc. In cases where the value of TH is much smaller than the transmitted frame size in bytes, then the value of comparison can be anywhere between −TH to TH with only small effect on the actual bandwidth allocated to the group VCs.

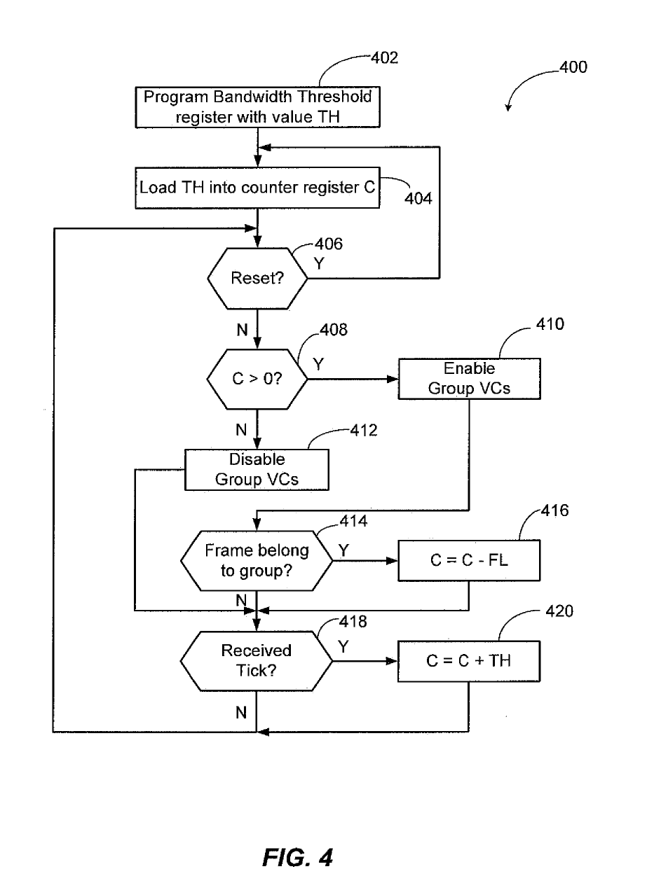

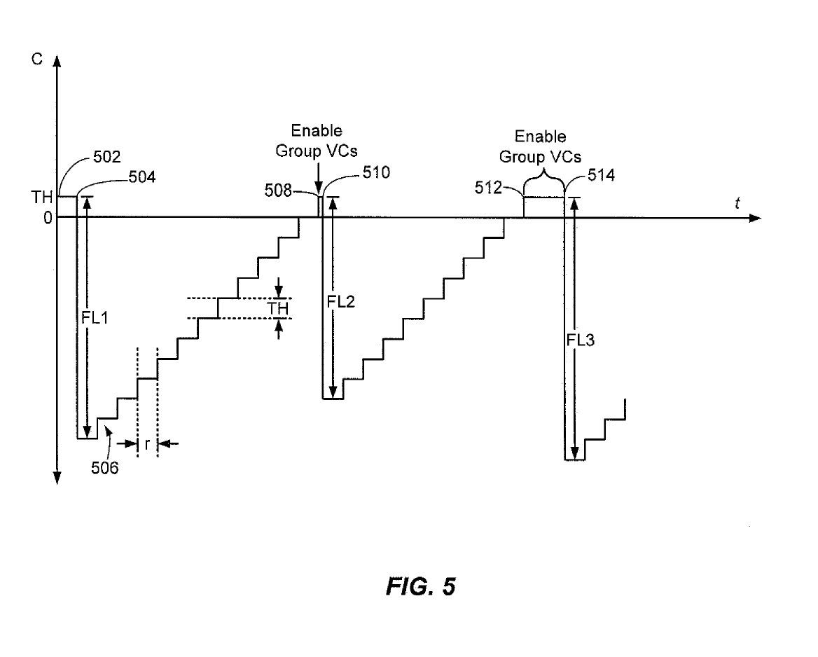

Discussion now turns to the operation of BW limiting circuit 300 in limiting the bandwidth of the group of VCs, as shown in the exemplary flowchart 400 of FIG. 4. Additionally, FIG. 5 illustrates an exemplary graph of the value of counter register C 304 over time. In FIG. 4, starting at step 402, the user/administrator can program a value TH in the group bandwidth threshold register (register 302 in FIG. 3). In the following step 404, value TH can be loaded into the counter register C. The current value C of counter register C 304 is shown by 502 in FIG. 5. In the following step 405, if a reset signal RST is received, the value stored in the threshold register 302 is again loaded into the counter register C 304. If no reset RST 314 signal is received, the current value C stored in the counter register C 304 can be compared to 0. If the current value of counter register C 304 is greater than 0, all the VCs within the group can be enabled for transmitting frames. If a frame has been transmitted, step 414 determines if the transmitted frame originated from a VC belonging to the group. If the transmitted frame was transmitted from a VC that did belong to the group, then the frame length FL (in bytes) can be subtracted from the current value of the counter register C 304 and stored back to the counter register C 304. In other words, the new value stored in the counter register C 304 can be C=C−FL1. This change in the current value of register counter C 304 is depicted by 504 in FIG. 5. Note that in the example shown in FIG. 5, the new value of register counter C 304 is negative. Referring back to step 408, if the value of the counter C 304 is less than or equal to 0, then the VCs within the group can be disabled. When the VCs are disabled, no frames associated with those VCs can be transmitted.

Step 418 in FIG. 4 checks if the ‘r’ tick has been received. Note that signal ‘r’ tick (shown as input 318 to multiplexer 308 in FIG. 3) can be a periodic pulse signal that occurs every ‘r’ seconds. If no ‘r’ tick signal has been received, then the execution can proceed to step 406. However, if an ‘r’ tick signal is received, the current value of the counter C 304 can be incremented by the value TH stored in the threshold register CTH. In other words, the new value of the counter register C 304 can be C=C+TH. This incremental increase in the value of the register counter C 304 is indicated by 506 in FIG. 5. Absent any reset RST signal, the execution can again proceed to step 408 where the current value of the counter register C 304 can be compared with 0. Assuming, for example, that the value of TH is considerably less than the frame length FL (typical values of frame length is around 2000 bytes), the current value of register counter C 304 will still be negative. This is also shown in FIG. 5 at 506. Therefore, the execution can proceed to step 412 where the VCs can be disabled. Again because the VCs have been disabled, no frames associated with those VCs will be transmitted. The execution can proceed to step 418 where the receipt of the ‘r’ tick signal is determined.

Therefore, as long as the value of the register counter C 304 remains negative, the execution can repeatedly proceed through steps 406-408-412-418-406. When an ‘r’ tick signal is received every r seconds, step 420 can also be executed after step 418 and before step 420. This can allow the value C of the counter register C 304 to increment by value TH every r seconds. Eventually, the current value of counter register C 304 can become greater than zero, which event is shown at 508 in FIG. 5. So when the execution reaches step 408, the comparison can result in the execution proceeding to step 410, where the VCs are again enabled for transmission. When a frame associated with a VC that belongs to the group is transmitted, the execution, in step 416, decrements the current value C of the counter register C 304 by the frame length FL2. This is shown at 510 in FIG. 5. Note that the frame length FL1 of the frame transmitted at 504 in FIG. 5 is different from the frame length FL2 of the frame transmitted at 510 in FIG. 5. This difference is not unusual. The maximum size of a Fibre Channel frame can be 2148 bytes, of which 2000 bytes can be data payload.

Note that counter register C 304 can have a value that is not greater than the threshold value TH. In other words, in step 420, when adding TH to the current value of C results in a value that is greater than TH, the adder can store the value TH, instead of the actual sum of C and TH, in the counter register C 304. For example, in FIG. 5 at 512 the counter register C has a value equal to TH. Although the counter value is greater than zero and the VCs are enabled, no frames are transmitted. This may occur for example, when no buffer credits are available to allow transmission. Signal ‘r’ tick can be received after a time period of r seconds. At this time, the operation C=C+TH will result in C=2TH. However, because 2TH is greater than TH, the adder can store a value TH in the counter register C 304. This can be implemented in several ways in the BW limiting circuit 300 of FIG. 3. In one instance, a comparator circuit can be included with the adder 310, where the comparator compares the result of C+TH with the value TH. Additional combinatorial logic can ensure that if the resultant value is greater than TH, then the value TH is passed on to the multiplexer 308.

Referring back to FIG. 5, the time between transmissions of two successive frames can be represented by T (in seconds). From observation, T can depend on three entities: threshold value TH, frame length FL, and the tick rate r. Using geometric analysis, the time T can be determined to be approximately equal to (FL×r)/TH. Qualitatively, this relationship can be observed from FIG. 3. If the frame length FL increases, the amount of time required for the counter to increment back to a positive value will also increase. If the threshold value increases, then the amount of time (i.e., the number of steps required) for the counter to reach a positive value decreases. Also, if the value of r increases, then it would take longer for the counter value to reach a positive value.

To simplify analysis, two assumptions can be made. One that the port transmits the maximum allowable frame size each time a frame is transmitted. Second that the VC has satisfied all other factors necessary for it to successfully transmit a frame when a VC is enabled for frame transmission by the BW limiting circuit, i.e., as soon as the counter becomes positive, the port is able to transmit the frame immediately. Both these assumptions are valid, considering the fact that they provide for the worst case conditions for which bandwidth limiting is to be provided. In other words the above two assumptions result in the maximum amount of bytes being transmitted per unit time, and the bandwidth limiting circuit should be able to limit the bandwidth under such conditions.

For maximum bandwidth, the pattern of counter C in FIG. 5 starting at 504 and ending at 508 will be periodically repeated over time with the frame length FL being equal to the maximum allowable frame length FLmax. In other words, the BW limiting circuit 300 allows transmission of FLmax bytes every T seconds (where T is the time between transmissions of two successive frames). Therefore, the maximum bandwidth BWmax can be expressed as BWmax=(FLmax/T) bytes per second. The value of T has been previously calculated to be equal to (FL×r)/TH. The value of T where the frame length is equal to FLmax will be equal to (FLmax×r)/TH. By substituting the expression of T in the equation for BWmax, we can determine the expression for BWmax to be equal to (TH/r) bytes per second. Therefore, the maximum bandwidth allowed by the BW limiting circuit 300 is directly proportional to the threshold value TH stored in the group bandwidth threshold register 302 and inversely proportional to the time period between periodic ‘r’ tick signals. This relationship can be evident from modifying TH and r in FIG. 5. For example, as TH increases, for the same value of r, the number of steps required, and consequently the amount of time required, for the counter value C to become positive becomes smaller. As a result, more frames can be transmitted per unit time. Also, for example, if r decreases, for the same value of TH, the time required for the counter value C to become positive becomes smaller. As a result, more frames can be transmitted per unit time. Of course, the bandwidth can be decreased by decreasing the value of TH and increasing the value of r.

As an example for demonstrating bandwidth limiting, the value of TH can be set to 50 and the value of r can be set to 8 micro-seconds. The frame length FL is assumed to be 2000 bytes. Initially, the counter register C 304 can be loaded with the value 50. Because this value is greater than zero, a frame can be transmitted. Once the frame length is subtracted from C, the resultant value in the register counter C 304 will be −1950. Every 8 micro-seconds the TH value of 50 will be added to C. Therefore every 8 micro-seconds the value of C will progress as −1950, −1900, −1850, and so on until the value becomes greater than zero to +50. When C is equal to +50 another frame can be transmitted and the FL value will be subtracted from C. The progression of C from −1950 to +50 in steps of 50 will require 40 increments. Therefore, from the instant the counter C was decremented to −1950 due to the transmission of the first frame to the instant when the C reaches +50 and transmission of the second frame takes place, 40×8 micro-seconds=320 micro-seconds will have elapsed. Within these 320 micro-seconds 2000 bytes of information was transmitted. Therefore, the bandwidth will be equal to (2000 bytes)/320 micro-seconds. This is equal to 50 M bits per second. In other words, setting the value of TH to 50 and r to 8 micro-seconds results in a maximum bandwidth of 50 M bits per second.

The same result can also be obtained by plugging in the values of TH and r in the expression of maximum bandwidth determined earlier, and will yield BWmax=50/8 micro-seconds=6.25×10⁶ bytes per second=50 M bits per second.

Setting the value of r to 8 micro-seconds produces a convenient relationship between the value TH and the resultant bandwidth, such that the resultant bandwidth is no more than TH Mbps. For example, if the required value of BWmax is 2 Gbps, then the value TH can be set to 2000.

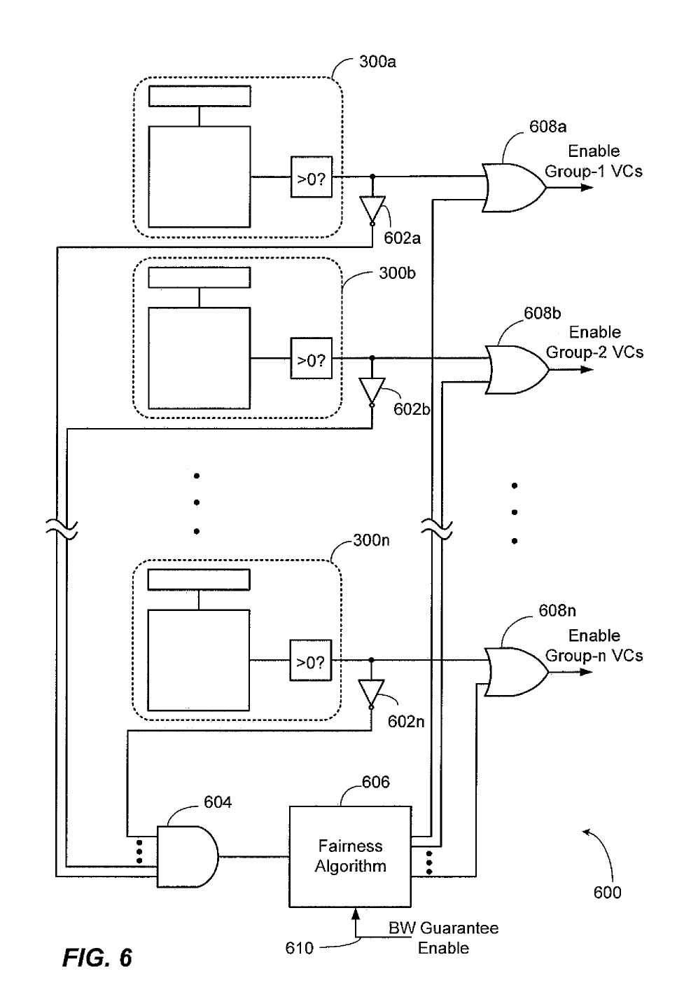

FIG. 6 illustrates an exemplary circuit 600 that provides bandwidth guarantee for a group of VCs associated with a port. The bandwidth guarantee circuit 600 can incorporate BW limiting circuit 300 in providing bandwidth guarantee to a group of VCs. For example, each of 300a, 300b, and 300n can be the same as the BW limiting circuit 300 disclosed in FIG. 3. Each group of VCs can be associated with one BW limiting circuit 300. For example, VCs belonging to group A can be associated with 300a, VCs belonging to group B can be associated with 300b, and VCs belonging to group N can be associated with 300n. Outputs of the comparators 306 of each of the BW limiting circuits can be fed to one input of an OR gate. For example, output of the 300a can be fed to one input of OR gate 608a. Output of 300b can be fed to one input of OR gate 608b. Similarly, output of 300n can be fed to one input of OR gate 608n. Outputs of each of the BW limiting circuits can also be inverted and fed to a AND gate 604. AND gate 604 is an n-input AND gate that receives outputs from inverters 602a-602n. Output of the AND gate 604 can be given to an enable input of a fairness algorithm (FA) block 606. The FA block 606 is used to fairly distribute frames among n VC groups. The FA block has n binary outputs. Each output represents an enable signal that enables the associated group of VCs for transmitting a frame. One output each of the FA block 606 is connected to one of the inputs of each of the n OR gates 608a-608n. Outputs of OR gates 608a-608n enable/disable VCs associated with groups A-N. VCs belonging to a group can be enabled either if the value of the counter C of that group is greater than zero or if the output of the FA block 606 for that group is 1.

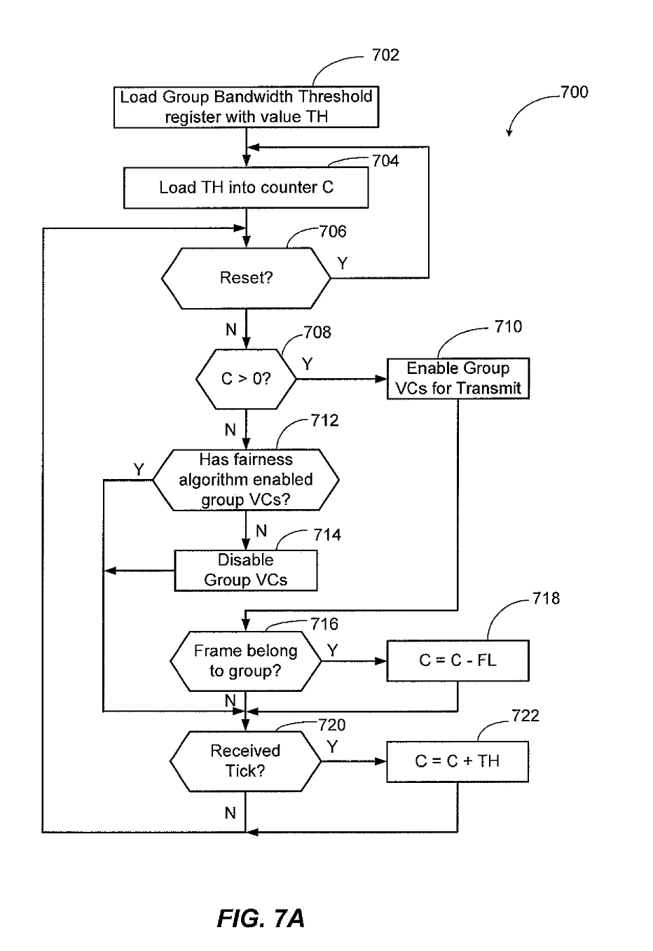

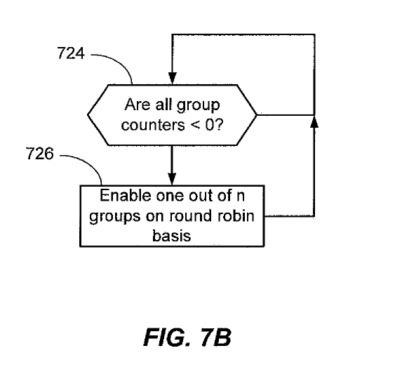

Operation of bandwidth guarantee circuit 600 can be described with the aid of the exemplary flowchart 700 shown in FIG. 7A. Although flowchart 700 show steps executed for a single group of VCs, each group can have a similar and independent flowchart associated with it. In step 702 the group bandwidth threshold register can be loaded with value TH. This value TH provides the minimum bandwidth that can be guaranteed by the bandwidth guarantee circuit 600. In step 704, the value TH can be loaded into the counter register C 304. In step 706, if a reset signal RST is detected, then the value of TH can be loaded into the counter register C 304. The reset signal can be asserted to load a new value of TH into the counter register C 304. If no reset signal is detected, the execution can move to step 708 where the value stored in the register counter C 304 can be compared to the value 0. If the value C is greater than 0, then the VCs associated with the group can be enabled to transmit frames. Once a frame is transmitted from one of the VCs from the group and its frame length FL is available, the frame length FL can be subtracted from the current value C of the counter register C 304 in step 720. If a ‘r’ tick input is detected in step 720, the counter value C can be incremented by the value TH in step 722. The execution then proceeds back to step 706.

Referring back to step 708, if the current value C of the register counter C 304 is less than or equal to 0, then the execution moves to step 712. If the fairness algorithm, shown in the FA block 606 in FIG. 6, has enabled the group VCs, then the execution can move to step 720, else if the fairness algorithm has not enabled the group VCs, then the group VCs are disabled. Note that the fairness algorithm can be based on a round-robin selection scheme, as shown in FIG. 7B. In step 724, if all the counters are determined to be less than zero, then in step 726 one of n groups is enabled to transmit frames. Alternatively, selecting which one of the n groups is enabled can be based on a weighted algorithm, which in turn can be based on the TH values for each group. During the time that all the counter values are less than zero, a new group can be selected as soon as a frame is transmitted. Alternatively, a new group can be selected every predetermined amount of time, e.g., r seconds. In step 720, if the ‘r’ tick signal is received, then the C is incremented by TH. Alternatively, if the fairness algorithm enables a group of VCs in step 712, the execution can move to step 716 instead of step 720, as shown in FIG. 7A. In this case, the current value C of counter register C 304 can be decremented if a transmitted frame belongs to the group of VCs that was enabled by the fairness algorithm. In other words, the counter value C of counter register C 304 is decremented irrespective of whether the enabling of the group of VCs was due to the fairness algorithm of due to the value C of counter register C 304 being greater than zero.

Comparing the bandwidth guarantee flowchart 700 of FIG. 7A to the bandwidth limiting flowchart 400 of FIG. 4, one can see that in bandwidth guarantee, group VCs may be enabled to transmit frames even though the counter value C is less than zero. As a result, the effective bandwidth for a group of VCs can be at least or greater than the bandwidth achieved solely with bandwidth limiting. Thus bandwidth guarantee, as shown in FIGS. 6-7B guarantees the associated group of VCs can achieve a bandwidth of at least BWmax. Bandwidth limiting, on the other hand, does not allow the bandwidth of the group of VCs to exceed more than BWmax.

Typically, values stored in the group bandwidth threshold registers of all groups can be selected such that the total bandwidth for all groups is less than or equal to the maximum port bandwidth. For example, let's assume that the value of r is 8 micro-seconds. Then the value TH for a group will specify a bandwidth of TH Mbps assigned to that group. For n groups, the total bandwidth assigned to port will be the sum of the values stored in each groups bandwidth threshold register. In other words, the total bandwidth of the port is greater than or equal to

$${\sum }_{i = 1}^{n} {TH}_{i} ,$$

where TH, is the value programmed into the group bandwidth threshold register for the i^{th} group. So, as an example, if there were three groups, each with the threshold value of 1000 (i.e., 1 Gbps), with the port bandwidth of 4 Gbps, the bandwidth guarantee circuit can guarantee each group with a bandwidth of 1 Gbps. Therefore, if each group can be utilized to the extent that it can transmit at a bandwidth of 1 Gbps, then the bandwidth guarantee circuit can enable sufficient frames for each group for the group to achieve 1 Gbps. Additional bandwidth required by each group can be provided from the remaining 1 Gbps bandwidth of the port, and this can be based on a fairness algorithm, as shown by way of example in FIG. 6.

The FA block 606 can also include an enable signal 610 that allows the activation/deactivation of bandwidth guarantee for a particular port. For example, if no bandwidth guarantee is required, the BW guarantee enable signal 610 is de-asserted. As a result the outputs of the FA block 606 coupled to the OR gates 608a-608n is pulled low. Because one of the two inputs to each OR gate is a zero, the output of each OR gate is dependent on only the other input. In other words, once the FA block 606 is disabled, the enable signals for each group will depend upon the outputs of their respective BW limiting circuits only.

Although the preceding descriptions of bandwidth limiting and bandwidth guarantee circuits have been described within the context of a network switch (e.g., 202 and 204 in FIG. 2), the same is also applicable for ports on devices other than switches. For example, the bandwidth limiting and bandwidth guarantee can be provided for virtual channels associated with a transmitting port on a network interface within a host device connected to the network. Such a network interface can be a host bus adaptor used to connect a host to a Fibre Channel fabric.

Furthermore, the preceding description of bandwidth limiting and bandwidth guarantee circuits is not limited to Fibre Channel networks, and can be used in direct link networks such as, Ethernet, wireless 802.11, etc., and packet switched networks such as the Internet.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A network device comprising:
a first register associated with a first group of virtual channels of a port;
first bandwidth limiting logic coupled to the first register and configured to repeatedly alter the value of the first register based on a first threshold value and frame lengths of frames transmitted from the first group; and
a first comparator coupled to the first register and configured to assert a first enable signal based on the comparison of the value of the first register with a first enable value,
wherein the first enable signal enables the first group of virtual channels for frame transmission.

2. The network device of claim 1, wherein the bandwidth limiting logic comprises:
a first incrementer coupled to the first register and configured to repeatedly increment the first register with the first threshold value;
a first decrementer coupled to the first register and configured to decrement the first register by a first frame length value, wherein the first frame length value is related to the length of a frame transmitted from any one of the first group of virtual channels.

3. The network device of claim 1, wherein enabling the first group of virtual channels comprises enabling only one of all virtual channels belonging to the first group of virtual channels based on a fairness algorithm.

4. The network device of claim 1, wherein the first threshold value is a function of a bandwidth limit value and the average time between repeatedly incrementing the first register.

5. The network device of claim 1, wherein the first group of virtual channels includes a single virtual channel.

6. The network device of claim 1, further comprising:
a second register associated with a second group of virtual channels of the port;
second bandwidth limiting logic coupled to the second register and configured to repeatedly alter the value of the second register based on a second threshold value and frame lengths of frames transmitted from the second group;
a second compartor coupled to the second register and configured to assert a second enable signal based on the comparison of the second register with a second enable value, wherein the second enable signal enables the second group of virtual channels for frame transmission; and
a bandwidth guarantee circuit coupled to the output of first comparator and the output of the second comparator, wherein the bandwidth guarantee circuit asserts one of the first enable signal and the second enable signal based on a selection scheme if both the first comparator and the second comparator fail to assert the first and second enable signals.

7. The network device of claim 6, the second bandwidth limiting logic comprising:
a second incrementer coupled to the second register and configured to repeatedly increment the second register with a second threshold value;
a second decrementer coupled to the second register and configured to decrement the second register by a second frame length value, wherein the second frame length value is related to the length of a frame transmitted from any one of the second group of virtual channels;

8. The network device of claim 7, wherein the first decrementer and the second decrementer do not decrement if the transmitted frame is transmitted due to enablement from the bandwidth guarantee circuit.

9. The network device of claim 7, wherein the first threshold value is a function of a first bandwidth limit value and the average time between repeatedly incrementing the first register, and wherein the second threshold value is a function of a second bandwidth limit value and the average time between repeatedly incrementing the second register.

10. A method for controlling bandwidth, the method comprising:
repeatedly altering a first register value, the first register value associated with a first group of virtual channels of a transmitting port, based on a first threshold value and frame lengths of frames transmitted from the first group;
comparing the first register value to a first enabling value; and
enabling the first group of virtual channels for frame transmission based on the comparison.

11. The method of claim 10, the act of repeatedly altering the first register value further comprising:
repeatedly incrementing the first register by the first threshold value; and
decrementing the first register by a first frame value each time a frame is transmitted from any virtual channel belonging to the first group, wherein the first frame value is related to the size of the transmitted frame;

12. The method of claim 10, wherein enabling the first group of virtual channels comprises enabling only one of all virtual channels belonging to the first group of virtual channels based on a fairness algorithm.

13. The method of claim 10, wherein the first threshold value is a function of a first bandwidth limit value and the average time between repeatedly incrementing the first register.

14. The method of claim 10, wherein the first group of virtual channels includes a single virtual channel.

15. The method of claim 10, further comprising:
repeatedly altering a second register value, the second register value associated with a second group of virtual channels of the transmitting port, based on a second threshold value and frame lengths of frames transmitted from the second group;
comparing the second register value to a second enabling value;
enabling the second group of virtual channels for frame transmission based on the comparison; and
enabling one of the first group and the second group based on a selection scheme if both the first group and the second group have not been enabled based on the respective comparisons.

16. The method of claim 15, the act of repeatedly altering the second register value further comprising:
repeatedly incrementing a second register by a second threshold value, wherein the second register is associated with a second group of virtual channels of the port;
decrementing the second register by a second frame value each time a frame is transmitted from any virtual channel from the second group, wherein the second frame value is related to the size of the transmitted frame;

17. The method of claim 15, further comprising disabling decrementing the first register and disabling decrementing the second register if the frame is transmitted based on the selection scheme.

18. The method of claim 15, wherein the first threshold value is a function of a first bandwidth limit value and the average time between repeatedly incrementing the first register, and wherein the second threshold value is a function of a second bandwidth limit value and the average time between repeatedly incrementing the second register.
